(19) United States
(12) Patent Application Publication
(10) Pub. No.: US 2007/0294164 A1
(43) Pub. Date: Dec. 20, 2007

(54) Credit account management

(75) Inventors: James R. Wilhelm, Golden, CO (US); Stacy Kissinger Leeds, Littleton, CO (US); Elaine Irene Plakorus, Arvada, CO (US); Daniel W. Zimmerman, Littleton, CO (US); Kay Lynn Kaffenberger, Arvada, CO (US); Jorge Euclides Pazmino Silvera, Aurora, CO (US)

Correspondence Address: KING & SPALDING LLP, 1180 PEACHTREE STREET, ATLANTA, GA, 30309-3521, US

(73) Assignee: Total System Services, Inc., Columbus, GA (US)

(21) Appl. No.: 11/805,615

(22) Filed: May 24, 2007

Related U.S. Application Data
(60) Provisional application No. 60/808,870, filed on May 26, 2006.

(51) Int. Cl. G06K 5/00; G06Q 40/00

(52) U.S. Cl. 705/38

(57) ABSTRACT

Temporarily increasing a credit limit of the credit account to accommodate a purchase by a buyer for goods and/or services from a merchant. An account management module can receive a request to increase the credit limit via an interface. The request can include information regarding the purchase and information regarding the credit limit increase, including an amount by which to increase the credit limit. The request also can include rules for decreasing the credit limit at the end of the credit limit increase term. The account management module can process the credit limit increase and decrease, in accordance with the request. The account management module also can transmit an email to the merchant with credit account information needed to process the purchase. For example, the email can include a link to a web site at which the merchant can obtain the credit account information upon successful completion of an authentication procedure.

### RELATED PATENT APPLICATION

This patent application claims priority under 35 U.S.C. §119 to U.S. Provisional Patent Application No. 60/808,870, entitled “Temporary Credit Limit Increase,” filed May 26, 2006, the complete disclosure of which is hereby fully incorporated herein by reference.

### FIELD OF THE INVENTION

The invention relates generally to credit account management and more particularly to temporarily increasing a credit limit of a credit account to accommodate a purchase and securely and efficiently providing credit account information to a merchant for completing the purchase.

### BACKGROUND OF THE INVENTION

A credit card allows an authorized user to charge goods or services (“purchases”) to a credit account. The user provides credit account information, such as an account number, expiration date, and security code, to a merchant offering the goods or services for purchase. The merchant verifies the validity of the credit account information using electronic verification systems.

The electronic verification systems communicate with an account issuer associated with the credit account to verify that the account information is valid and that the account is able to accept the charge. For example, the electronic verification systems can determine whether an available balance and/or credit limit associated with the account is large enough to accommodate the cost of the purchase. Upon successful verification, the purchase proceeds, with funds being transferred from a bank account associated with the account issuer to a bank account associated with the merchant. The account issuer periodically bills the user and/or another person or entity responsible for the account, such as an account administrator, for the purchases charged to the account.

Typically, businesses establish multiple credit accounts with multiple account issuers. The businesses distribute credit cards and/or credit account information associated with the credit accounts to their employees and other agents for use in making purchases. In some cases, the businesses assign the credit cards and/or credit accounts on an agent by agent basis. In other cases, the businesses assign the credit cards and/or credit accounts on a purchase by purchase basis.

For example, a business can select an account from a pool of available accounts for use in making a particular purchase from a merchant. The business can provide a credit card and/or account information corresponding to the selected account to the agent for use in making the purchase. The agent can then provide the credit card and/or account information to the merchant for processing the purchase. This process involves many inefficiencies, most notably the delay involved in transferring the credit card and/or account information from the business to the agent and from the agent to the merchant.

The process also makes the business' account information available to multiple persons who might improperly or fraudulently use the account information to make unauthorized purchases. To prevent such improper and fraudulent uses, businesses typically establish the business credit accounts with relatively low credit limits. The lower the credit limit, the lower the potential loss incurred by the business due to the improper and fraudulent uses. Similarly, a low credit limit can prevent an unscrupulous user from making large, unauthorized purchases. However, the low credit limit also can prevent an authorized user from making a large, authorized purchase.

Thus, a need exists in the art for an improved system and method for managing credit accounts. In particular, a need exists in the art for an efficient system and method for providing credit account information to merchants. A further need exists in the art for a system and method for disallowing unauthorized credit account purchases while allowing large, authorized credit account purchases.

### SUMMARY OF THE INVENTION

The invention provides systems and methods for managing credit accounts. Specifically, the invention provides systems and methods for temporarily increasing a credit limit of a credit account to accommodate a purchase. A temporary credit limit increase can allow large, authorized credit account purchases during the term of the credit limit increase while disallowing unauthorized credit account purchases outside the term of the credit limit increase.

An interface of an account management system can include one or more data entry fields configured to receive information from a buyer planning to complete a purchase of at least one good and/or service from a merchant. The terms “data entry field” and “data field” are used herein to refer to any means for receiving information, including, without limitation, a text entry field, a check box, a radio button, and a selection menu. The term “enter” is used herein to refer to providing information via a data entry field. The term “buyer” is used herein to refer to a person or entity that purchases goods and/or services from another, including any employees, agents, and account administrators of such a person or entity.

The information received in the data entry fields of the interface can include information regarding the purchase, such as information identifying the buyer, information identifying the merchant, information identifying the purchase, and a purchase price of the purchase. For example, the information can include a name and/or email address of the buyer, a name and/or address of the merchant, an account number of an account of the buyer to use for the purchase, and one or more invoice numbers of one or more invoices associated with the purchase.

The buyer can use the interface to request a temporary credit limit increase for the credit account of the buyer. For example, the buyer can enter an amount by which to increase the credit limit (an “increase amount”) into a data field of the interface. The increase amount can equal the purchase price of the purchase. Alternatively, the increase amount can be another amount of money that, when added to an available balance of the credit account, will make the available balance of the credit account greater than or equal to the purchase price.

The buyer can enter into the interface a set of rules for determining the term of the credit limit increase. For example, the buyer can enter a date upon which the credit limit increase term will expire, regardless of whether the purchase has been completed by that date (an “expiration date”). The buyer also can enter a set of rules for ending the credit limit increase term upon completion of the purchase.

For example, these rules can include a dollar amount or percentage. If the buyer's credit account has a current available account balance less than or equal to the dollar amount or percentage specified in the rules, then the purchase has been completed, and the credit limit increase is no longer necessary. The term “current available account balance” is used herein to refer to a difference between the credit limit of the credit account and the current balance of the credit account. In certain embodiments, the current available account balance can include an absolute value of the difference between the credit limit of the credit account and the current balance of the credit account. For simplicity, the date on which the credit limit increase term ends is referred to herein as a “decrease date,” and the dollar amount or percentage specified in the rules is referred to herein as a “current available account balance level.”

The buyer can enter into the interface a set of rules for decreasing the credit limit of the credit account on the decrease date. For example, the buyer can enter an amount by which to decrease the credit limit on the decrease date (a “decrease amount”) and an account status to apply to the account upon decreasing the credit limit. For example, the decrease amount can equal the increase amount. The account status can be open or closed. An “open” credit account is a credit account that can be used to make purchases. A “closed” credit account is a credit account that cannot be used to make purchases. For example, the buyer can specify that the account will be closed upon completion of the credit limit decrease. A person of ordinary skill in the art, having the benefit of the present disclosure, will recognize that several other account statuses exist. By way of example only, an account status can include an indication regarding account activity, an indication that the buyer is bankrupt, an indication that the credit account has been used fraudulently, an indication that the account balance is past-due, etc.

An account management module of the account management system can receive the buyer's request from the interface. The account management module can increase the credit limit by the increase amount. The account management module can determine the decrease date by comparing the current date with the expiration date specified in the buyer's request and/or by monitoring activity of the credit account to determine whether the current available account balance of the credit account is less than or equal to the current available account balance level specified in the rules.

The account management module can decrease the credit limit by the decrease amount on the determined decrease date. The account management module can change the account status of the account, pursuant to the rules entered by the buyer, upon decreasing the credit limit. For example, the account management module can communicate with an account issuer of the credit account to increase and decrease the credit limit of the credit account, to change the account status of the credit account, and to monitor the current available account balance of the credit account. The term “account issuer” is used herein to refer to a person or entity that provides the credit account for use by the buyer, and any person, entity, or software processor operating on behalf of such a person or entity, such as Total System Services, Inc. (“TSYS”).

The invention also provides systems and methods for securely and efficiently providing credit account information to the merchant for completing the purchase. In particular, the invention provides systems and methods for providing the credit account information to the merchant via a secure web site, upon successful completion of an authentication procedure.

The account management module of the account management system can generate an email notification to the merchant upon increasing the credit limit of the credit account. The email can include a portion of the information entered by the buyer in the credit limit increase request. For example, the email can include information identifying the buyer, information identifying the merchant, the purchase price of the purchase, and a portion of an invoice number associated with the purchase. The email also can include a link and/or a web site address of a secure web site at which the merchant can obtain credit account information necessary for processing the purchase with the credit account. For example, the credit account information can include a credit account number, expiration date, and security code of the credit account.

Prior to providing such information, an authentication procedure can verify the merchant's authorization to view the credit account information. Specifically, the merchant can enter information regarding the purchase into data entry fields of the web site. For example, the merchant can enter information included in the email and information not included in the email, such as information included in the invoice associated with the purchase.

The account management module can receive the information entered into the web site and verify its authenticity by comparing it to information previously received from the buyer regarding the purchase. For example, the account management module can compare the information received from the web site with information received in the buyer's request to temporarily increase the credit limit of the credit account. If the information matches, then the account management module can provide the credit account information to the merchant. The account management module can generate a signal including the credit account information and transmit the signal to the merchant. For example, the account management module can display the credit account information on the web site or transmit an email including at least a portion of the credit account information to the merchant.

These and other aspects, objects, features, and advantages will become apparent to a person skilled in the art upon consideration of the following detailed description of illustrated exemplary embodiments, which include the best mode of carrying out the invention as presently perceived.

### BRIEF DESCRIPTION OF THE DRAWINGS

FIG. 1 is a block diagram depicting a system for managing a credit account, in accordance with certain exemplary embodiments.

FIG. 2 is a flow chart depicting a method for managing a credit account, according to certain exemplary embodiments.

FIG. 3 is a flow chart depicting a method for receiving a request to temporarily increase a credit limit, according to certain exemplary embodiments.

FIG. 4 is a flow chart depicting a method for notifying a merchant of a purchase, according to certain exemplary embodiments.

FIG. 5 is a flow chart depicting a method for decreasing a credit limit, according to certain exemplary embodiments.

FIG. 6 is a flow chart depicting a method for selecting a credit account, according to certain exemplary embodiments.

FIG. 7 is an exemplary interface of an account management system, in accordance with certain exemplary embodiments.

FIG. 8 is an exemplary email notification to a preferred merchant of a buyer of a purchase, in accordance with certain exemplary embodiments.

FIG. 9 is an exemplary email notification to a merchant of a purchase, in accordance with certain alternative exemplary embodiments.

### DETAILED DESCRIPTION OF EXEMPLARY EMBODIMENTS

The invention is directed to systems and methods for managing credit accounts. Specifically, the invention provides systems and methods for temporarily increasing a credit limit of a credit account to accommodate a purchase by a buyer for goods and/or services from a merchant and for securely and efficiently providing credit account information to the merchant for completing the purchase.

The invention includes a computer program that embodies certain of the functions described herein and illustrated in the appended flow charts. However, it should be apparent that there could be many different ways of implementing the functions in computer programming, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

Turning now to the drawings, in which like numerals indicate like elements throughout the figures, exemplary embodiments are described in detail.

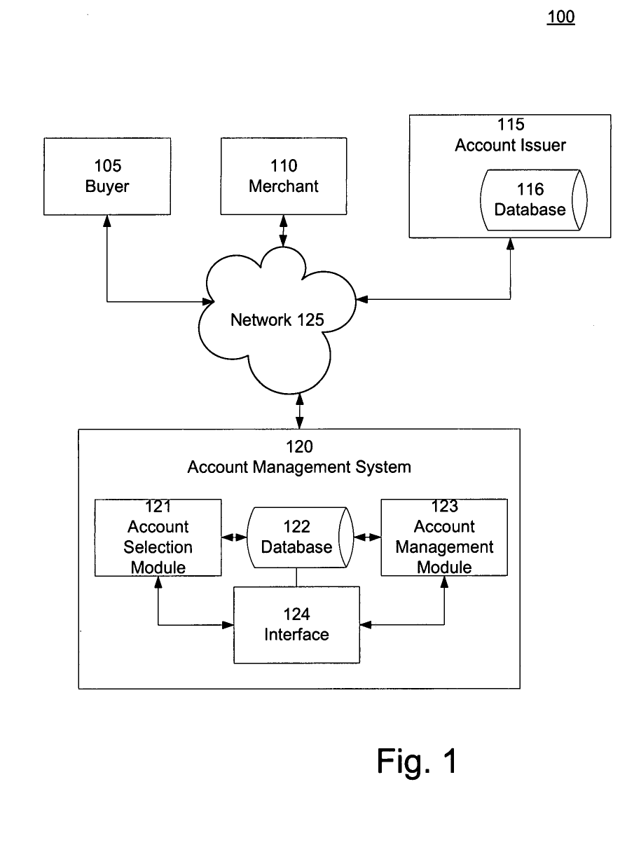

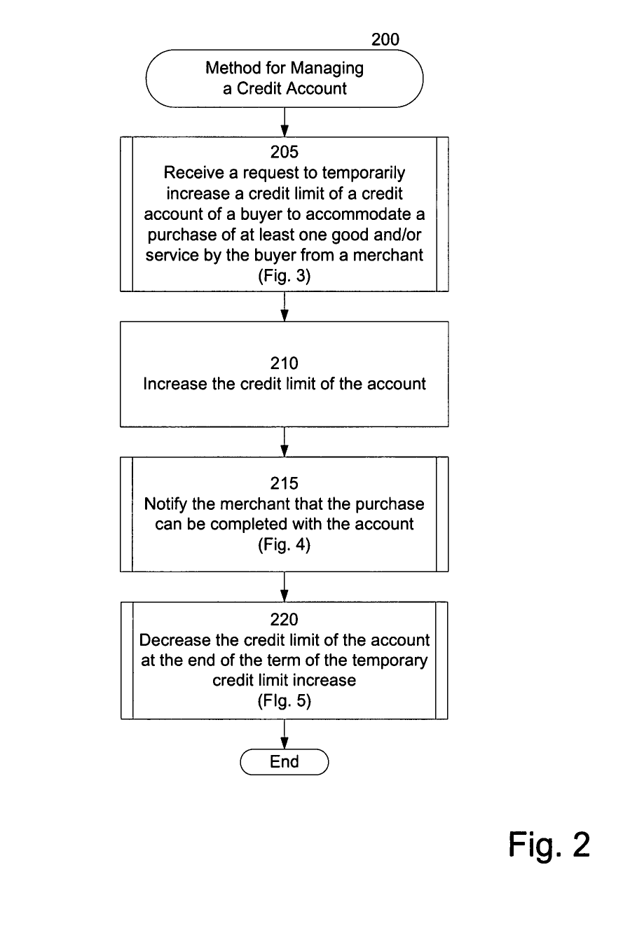

FIG. 1 is a block diagram depicting a system 100 for managing a credit account, in accordance with certain exemplary embodiments. The system 100 is described below with reference to the methods illustrated in FIGS. 2-6.

FIG. 2 is a flow chart depicting a method 200 for managing a credit account, in accordance with certain exemplary embodiments. The exemplary method 200 is illustrative and, in alternative embodiments, certain steps can be performed in a different order, in parallel with one another, or omitted entirely, and/or certain additional steps can be performed without departing from the scope and spirit of the invention. The method 200 is described below with reference to FIGS. 1 and 2.

In step 205, an account management module 123 of an account management system 120 receives a request to temporarily increase a credit limit of a credit account of a buyer 105. The temporary increase will accommodate a purchase of at least one good and/or service by the buyer 105 from a merchant 110. For example, the buyer 105 can submit the request to the account management module 123 via a network 125.

The network 125 can include any wired or wireless telecommunication means by which computerized devices can exchange data, including for example, a local area network (LAN), a wide area network (WAN), an intranet, an Internet, or any combination thereof. For example, the buyer 105 can submit the request to temporarily increase the credit limit of the credit account to the account management module 123 via an interface 124 of the account management system 120 (accessible via the network 125). For example, the interface 124 can be displayed on a display (not shown) of the buyer 105.

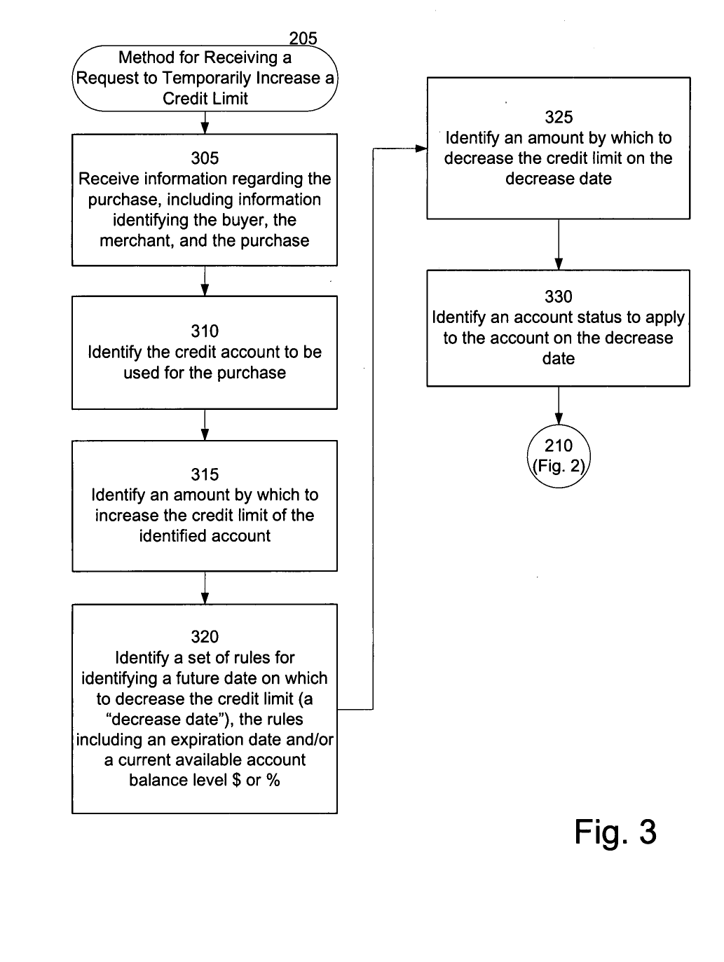

The request can include information regarding the purchase, such as information identifying the buyer 105, information identifying the merchant 110, information identifying the purchase, and a purchase price of the purchase. The request also can include information regarding the temporary credit limit increase, including an amount by which to increase the credit limit (an “increase amount”), a set of rules for determining the end of the term of the credit limit increase (a “decrease date”), and an amount by which to decrease the credit limit on the decrease date (a “decrease amount”). Step 205 is described in more detail below with reference to FIG. 3.

In step 210, the account management module 123 increases the credit limit of the credit account, in response to the request received in step 205. For example, the account management module 123 can increase the credit limit by the increase amount and/or purchase price identified in the request. In certain exemplary embodiments, the account management module 123 can communicate with an account issuer 115 of the credit account to increase the credit limit of the credit account. The account issuer 115 includes a person or entity that provides the credit account for use by the buyer 105 and any person, entity, or software processor operating on behalf of such a person or entity. For example, the account issuer 115 can include MasterCard® and a company that provides payment processing solutions for MasterCard®, such as TSYS. In certain alternative exemplary embodiments, the account issuer 115 can include the account management module 123, the account management system 120, and/or the interface 124. For example, the account issuer 115 and/or account management module 123 can increase the credit limit by updating a credit account record in the database 116 of the account issuer 115. By way of example only, the account management module 123 can generate and transmit a propagated signal to the account issuer 115 to update the credit account record.

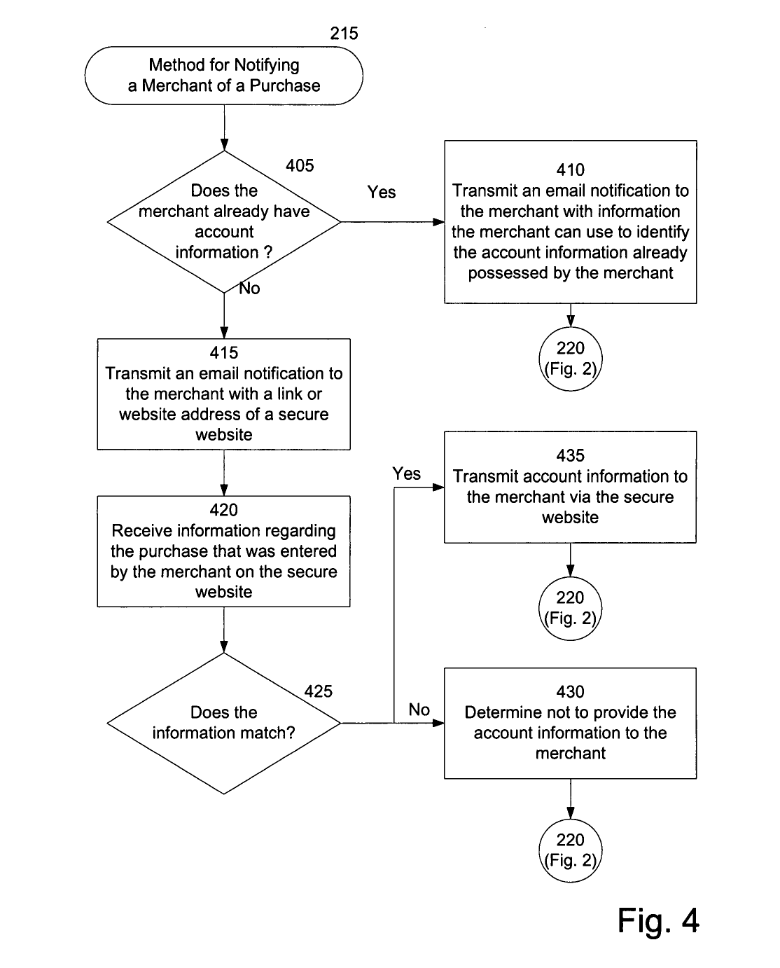

In step 215, the account management module 123 notifies the merchant 110 that the purchase can be completed with the credit account. For example, the account management module 123 can submit an email notification to the merchant 110 via the network 125. The notification can include information regarding the purchase, such as information identifying the buyer 105, information identifying the purchase, a portion of an account number of the buyer's credit account, and/or a link or web site address of a web site at which the merchant 110 can obtain account information of the credit account for processing the purchase. In certain exemplary embodiments, the account management module 123 also can transmit an email notification (or other notification) to the buyer 105, informing the buyer 105 that the credit limit has been increased. Step 215 is described in more detail below with reference to FIG. 4.

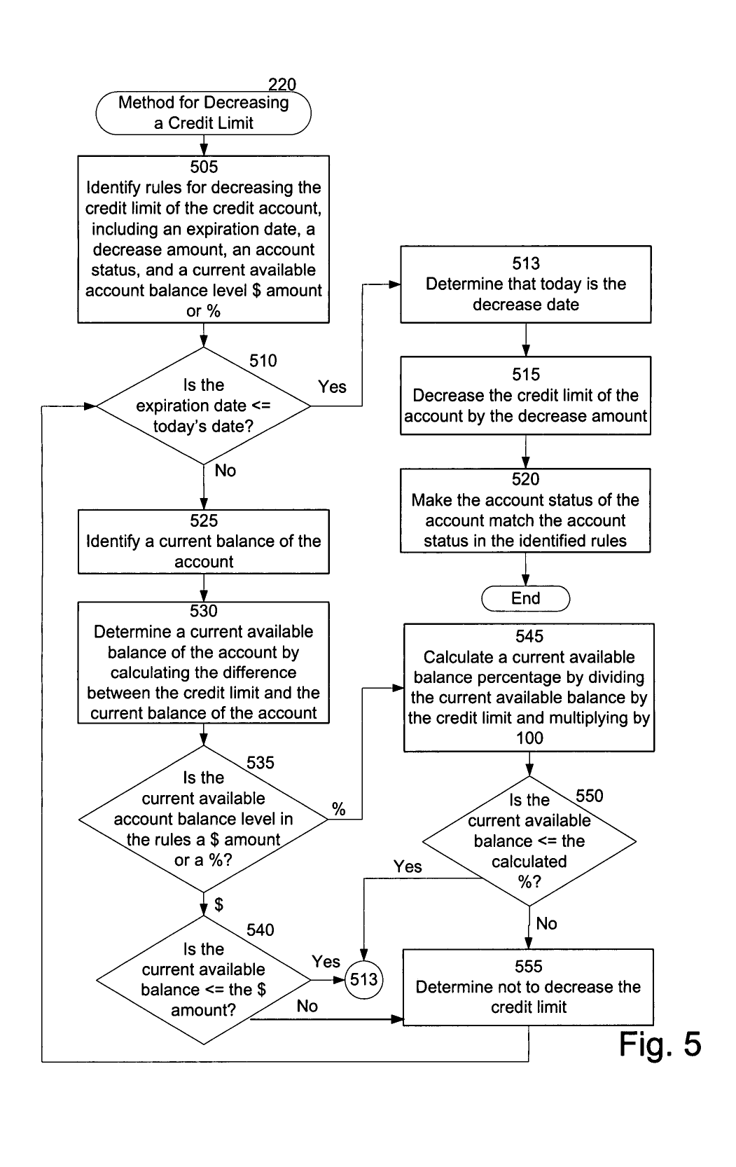

In step 220, the account management module 123 decreases the credit limit of the credit account on the decrease date. The account management module 123 can determine the decrease date based on one or more rules associated with the credit account. For example, the rules can be based on information provided by the buyer 105 in the request received in step 205. Similarly, the amount by which the credit limit is decreased on the decrease date—the decrease amount—can be determined based on one or more rules associated with the credit account and/or provided by the buyer 105 in the request received in step 205. Step 220 is described in more detail below with reference to FIG. 5.

FIG. 3 is a flow chart depicting a method 205 for receiving a request to temporarily increase a credit limit, in accordance with certain exemplary embodiments, as referred to in step 205 of FIG. 2. The exemplary method 205 is illustrative and, in alternative embodiments, certain steps can be performed in a different order, in parallel with one another, or omitted entirely, and/or certain additional steps can be performed without departing from the scope and spirit of the invention. The method 205 is described below with reference to FIGS. 1 and 3.

In step 305, the account management module 123 receives information regarding the purchase, including information identifying the buyer 105, information identifying the merchant 110, and information identifying the purchase. For example, the account management module 123 can receive a name and email address of the buyer 105, a name and email address of the merchant 110, and at least one invoice number associated with the purchase. In certain exemplary embodiments, the account management module 123 can receive the information regarding the purchase from the interface 124. For example, the buyer 105 can enter the information in one or more data entry fields of the interface 124. Alternatively, the buyer 105 can submit the information to the account management module 123 via an email or another suitable data transfer means.

In step 310, the account management module 123 identifies the credit account to be used for the purchase. For example, the account management module 123 can identify the credit account based on information provided by the buyer 105 via the interface 124 or another suitable data transfer means. In certain exemplary embodiments, such information provided by the buyer 105 can include at least a portion of a credit account number associated with the credit account. The information also can include an expiration date and/or security code associated with the credit account. In certain exemplary embodiments, the buyer 105 can select the credit account from a list of available credit accounts displayed on the interface 124.

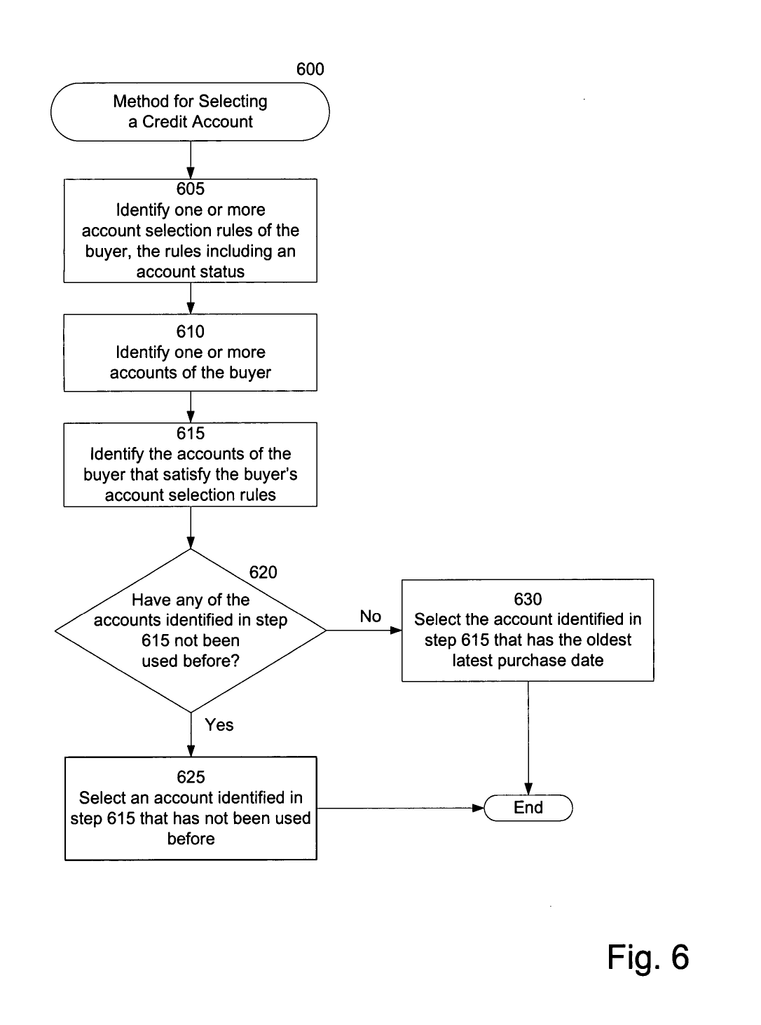

Information regarding the identified credit account can be stored in a database accessible to the account management module 123, such as the database 122 of the account management system 120 and/or or a database 116 of the account issuer 115. For example, the account management module 123 can identify the credit account by matching certain information provided by the buyer 105 with information stored in one or more of the databases 116 and 122. Certain alternative exemplary embodiments for identifying a credit account for a purchase are described below, with reference to FIG. 6.

In step 315, the account management module 123 identifies the increase amount. For example, the account management module 123 can identify the increase amount based on information provided by the buyer 105 via the interface 124 or another suitable data transfer means. The increase amount can equal the purchase price of the purchase. Alternatively, the increase amount can be another amount of money that, when added to an available balance of the credit account, will make the available balance of the credit account greater than or equal to the purchase price.

In certain exemplary embodiments, the increase amount can include a percentage variance or a dollar amount variance. The variance can account for additional costs associated with the purchase, including taxes and shipping costs, that can be unknown at the time of the credit limit increase request. For example, the increase amount can include a variance of 10% of the purchase price. Similarly, the variance can accommodate a purchase having an actual purchase price that is greater than the purchase price designated by the buyer 105 in the credit limit increase request. In certain exemplary embodiments, the account management module 123 can store the identified increase amount in the database 122.

In step 320, the account management module 123 identifies a set of rules for identifying the decrease date. For example, the account management module 123 can identify the rules for identifying the decrease date based on information provided by the buyer 105 via the interface 124 or another suitable data transfer means. The rules can include an expiration date on which the credit limit increase term will expire, regardless of whether the purchase has been completed by that date. The rules also can include rules for ending the credit limit increase term upon completion of the purchase.

For example, the rules can include a current available account balance level dollar amount or percentage. If the buyer's credit account has a current available account balance less than or equal to the current available account balance level dollar amount or percentage specified in the rules, then the purchase has been completed, and the credit limit increase is no longer necessary. For example, if the current available account balance level is 1% of the credit limit, the credit limit has been increased to $1000, and the current available account balance is $9, then the current available account balance is 0.9% of the credit limit, which is less than the current available account balance level. Therefore, the account management module 123 can determine that the purchase has been completed and can end the term of the credit limit increase. In certain exemplary embodiments, the account management module 123 can store the identified rules in the database 122.

In step 325, the account management module 123 identifies the decrease amount. For example, the account management module 123 can identify the decrease amount based on information provided by the buyer 105 via the interface 124 or another suitable data transfer means. The decrease amount can equal the increase amount or another suitable amount identified by the buyer 105. In certain exemplary embodiments, the account management module 123 can store the identified decrease amount in the database 122.

In step 330, the account management module 123 identifies an account status to apply to the credit account on the decrease date. For example, the account management module 123 can identify the account status based on information provided by the buyer 105 via the interface 124 or another suitable data transfer means. The account status can be open or closed. For example, the buyer 105 can specify that the account will be closed upon completion of the credit limit decrease. In certain exemplary embodiments, the account management module 123 can store the identified account status in the database 122.

FIG. 4 is a flow chart depicting a method 215 for notifying a merchant 110 of a purchase, in accordance with certain exemplary embodiments, as referred to in step 215 of FIG. 2. The exemplary method 215 is illustrative and, in alternative embodiments, certain steps can be performed in a different order, in parallel with one another, or omitted entirely, and/or certain additional steps can be performed without departing from the scope and spirit of the invention. The method 215 is described below with reference to FIGS. 1 and 4.

In step 405, the account management module 123 determines whether the merchant 110 already has account information for the credit account to be used for the purchase. For example, the merchant 110 can be a “preferred merchant” of the buyer 105, with the buyer's credit account information already on file. The account management module 123 can determine whether the merchant 110 already has the account information based on information provided by the buyer 105 via the interface 124 or another suitable means. For example, the buyer 105 can inform the account management module 123 that the merchant 110 is a preferred merchant and/or that the merchant 110 already has the credit account information. In addition, or in the alternative, the account management module 123 can maintain a list of preferred merchants of the buyer 105 in the database 122. The account management module 123 can consult the list of preferred merchants to determine whether the merchant 110 already has the account information.

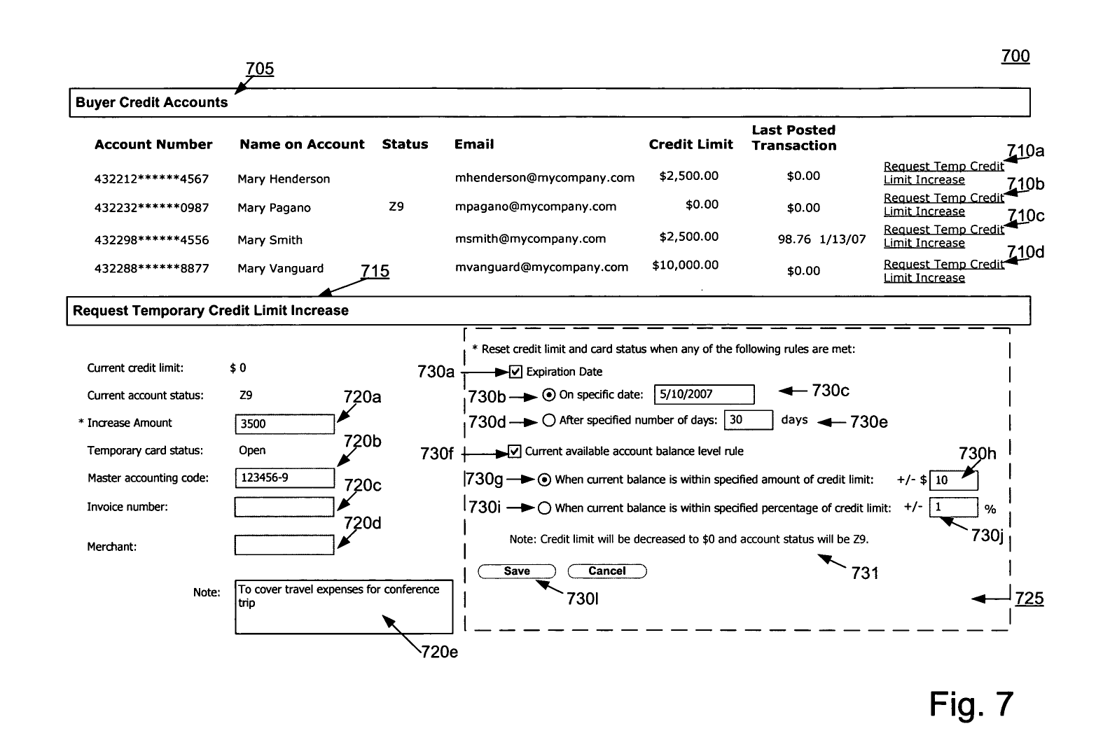

If the account management module 123 determines in step 405 that the merchant 110 already has the account information, then the method 215 branches to step 410. In step 410, the account management module 123 transmits an email notification to the merchant 110. The email includes information the merchant 110 can use to identify the account information already possessed by the merchant 110. For example, the email can include a portion of the account number of the credit account, such as the last 4 digits of the credit account. Alternatively, if the buyer 105 only has one credit account, then the email can simply include information identifying the buyer 105. An exemplary email notification to a preferred merchant is described below, with reference to FIG. 7.

If the account management module 123 determines in step 405 that the merchant 110 does not already have the account information, then the method 215 branches to step 415. In step 415, the account management module 123 transmits an email notification to the merchant 110. The email includes a link and/or a web site address of a secure web site at which the merchant 110 can obtain the account information necessary for processing the purchase with the credit account. For example, the web site can include the interface 124 of the account management system 120 or another web page or interface accessible to the merchant 110 via the network 125.

The email can include a portion of the information provided in the request to increase the credit limit in step 205 of FIG. 2. For example, the email can include information identifying the buyer, information identifying the merchant, and an incomplete portion of an invoice number associated with the purchase. An exemplary email notification with a link and/or a web site address to a secure web site is described below with reference to FIG. 10.

In steps 420-425, the merchant 110 accesses the secure web site, where the merchant 110 completes an authentication procedure. The authentication procedure verifies the merchant's authorization to view the credit account information prior to providing the merchant 110 with the credit account information in step 435. Specifically, in step 420, the account management module 123 receives information regarding the purchase that was entered by the merchant 110 on the secure web site. The web site can include one or more data fields for receiving the information entered by the merchant 110.

The merchant 110 can enter both information that was included in the email transmitted in step 415 and information that was not included in the email. For example, where the email included an incomplete portion of an invoice number associated with the purchase, the merchant 110 can enter the complete invoice number (from an invoice associated with the purchase). The ability of the merchant 110 to provide such information authenticates the merchant's identity and authorization to view the credit account information.

In step 425, the account management module 123 compares the information received in step 420 with information previously received in the request to increase the credit limit (in step 205 of FIG. 2) to determine whether the information matches. If so, then the method 215 branches to step 430. In step 430, the account management module 123 transmits the account information to the merchant 110. For example, the account management module 123 can transmit the account information to the merchant 110 via the secure web site or via another suitable data transmission means.

If the account management module 123 determines, in step 425, that the compared information does not match, then the method 215 branches to step 435. In step 435, the account management module 123 determines to not provide the merchant 110 with the account information. Because the information provided by the merchant 110 does not match the previously received information regarding the purchase, the account management module 123 has been unable to authenticate the merchant's identity and authorization to view the account information. Thus, the account management module 123 will not provide the merchant 110 with the account information.

In certain exemplary embodiments, the account management module 123 can notify the buyer 105 of the determination to not provide the merchant 110 with the account information. For example, the account management module 123 can transmit an email to the buyer 105, informing the buyer 105 of the failure of the merchant 110 to successfully complete the authentication procedure of steps 420-425 of FIG. 4. If the merchant 110 actually is authorized to view the account information, then the buyer 105 can provide the account information directly to the merchant 110 and/or override the determination of the account management module 123, in certain exemplary embodiments.

In certain alternative exemplary embodiments, the account management module 123 can transmit an email notification only to the buyer 105. The email notification can advise the buyer 105 that the credit limit of the buyer's credit account has been raised. The buyer 105 can provide the merchant 110 with credit account information of the credit account for processing of the purchase.

FIG. 5 is a flow chart depicting a method 220 for decreasing a credit limit, in accordance with certain exemplary embodiments, as referred to in step 220 of FIG. 2. The exemplary method 220 is illustrative and, in alternative embodiments, certain steps can be performed in a different order, in parallel with one another, or omitted entirely, and/or certain additional steps can be performed without departing from the scope and spirit of the invention. The method 220 is described below with reference to FIGS. 1 and 5.

In step 505, the account management module 123 identifies rules for decreasing the credit limit of the credit account, including rules for determining the decrease date, the decrease amount, and the account status to apply to the credit account upon decreasing the credit limit. For example, the identified rules can include the rules for determining the decrease date identified in step 320 of FIG. 3, the decrease amount identified in step 325 of FIG. 3, and the account status identified in step 330 of FIG. 3.

Specifically, the rules for determining the decrease date can include an expiration date on which the credit limit increase term will expire, regardless of whether the purchase has been completed by that date, as well as rules for ending the credit limit increase term upon completion of the purchase. For example, the rules can include a current available account balance level dollar amount or percentage, as discussed above with reference to step 320 of FIG. 3. In certain exemplary embodiments, the account management module 123 can identify the rules for decreasing the credit limit of the credit account in the database 122.

In step 510, the account management module 123 determines whether the identified expiration date is on or before the then-current date (“today's date”). If so, then the account management module 123 can determine to decrease the credit limit of the credit account, regardless of whether the purchase has been completed yet. Specifically, if the account management module 123 determines that the expiration date is on or before today's date, then the method 220 branches to step 513, where the account management module 123 determines that today is the decrease date.

In step 515, the account management module 123 decreases the credit limit of the account by the decrease amount identified in step 505. In step 520, the account management module 123 makes the account status of the credit account match the account status identified in step 505. For example, where the account status identified in step 505 is closed, the account management module 123 can close the account in step 520. Alternatively, where the account status identified in step 505 is open, the account management module 123 can leave the account open in step 520. For example, the account management module 123 can communicate with the account issuer 115 and/or the database 116 of the account issuer 115 to decrease the credit limit of the credit account and/or to change the account status of the credit account. For example, the account issuer 115 and/or account management module 123 can decrease the credit limit and/or change the account status of the credit account by updating a credit account record in the database 116 of the account issuer 115. By way of example only, the account management module 123 can generate and transmit a propagated signal to the account issuer 115 to update the credit account record.

If the account management module 123 determines in step 510 that the expiration date is not on or before today's date in step 510, then the account management module 123 can determine to not decrease the credit limit of the account until the account management module 123 determines that the purchase has been completed in steps 525-550. Specifically, if the account management module 123 determines in step 510 that the expiration date is not on or before today's date in step 510, then the method 220 branches to step 525, where the account management module 123 identifies a current balance of the credit account. For example, the account management module 123 can communicate with the account issuer 115 and/or the database 116 of the account issuer 115 to identify to current balance of the account.

The term “current balance” is used herein to refer to a total amount of money owed for the credit account at a particular point in time. For example, where a buyer 105 makes a $1,000 purchase with a credit account having a $0 starting balance, the current balance of the credit account upon completing the purchase is $1,000. In step 530, the account management module 123 determines an available balance of the account by calculating the difference between the credit limit and the current balance of the account. For example, where the credit limit is $1,005 and the current balance is $1,000, the available balance is $5.

In step 535, the account management module 123 determines whether the current available account balance level in the rules identified in step 505 is a dollar amount or a percentage. If the current available account balance level is a dollar amount, then the method 220 branches to step 540. In step 540, the account management module 123 determines whether the available balance determined in step 530 is less than or equal to the current available account balance level dollar amount. If so, then the account management module 123 can determine that the purchase has been completed and, therefore, that the credit limit should be decreased. Specifically, if the account management module 123 determines that the available balance determined in step 530 is less than or equal to the current available account balance level dollar amount in step 540, then the method 220 branches to step 513 discussed above.

If the account management module 123 determines that the available balance determined in step 530 is not less than or equal to the current available account balance level dollar amount in step 540, then the account management module 123 can determine that the purchase has not been completed and, therefore, that the credit limit should not be decreased. Specifically, if the account management module 123 determines that the available balance determined in step 530 is not less than or equal to the current available account balance level dollar amount in step 540, then the method 220 branches to step 555, where the account management module 123 determines to not decrease the credit limit. Then, the method 220 branches back to step 510 to continue monitoring the expiration date and current balance of the credit account until the decrease date.

If the account management module 123 determines in step 535 that the current available account balance level in the rules identified in step 505 is a percentage, then the method 220 branches to step 545. In step 545, the account management module 123 calculates an available balance percentage by dividing the available balance of the credit account by the credit limit of the credit account and multiplying by 100. For example, where the available balance of the credit account is $5 and the credit limit is $1,000, then the available balance percentage equals 0.5%.

In step 550, the account management module 123 determines whether the available balance percentage calculated in step 545 is less than or equal to the current available account balance level percentage identified in step 505. If so, then the account management module 123 can determine that the purchase has been completed and, therefore, that the credit limit should be decreased. Specifically, if the account management module 123 determines that the available balance percentage calculated in step 545 is less than or equal to the current available account balance level percentage in step 550, then the method 220 branches to step 513 discussed above.

If the account management module 123 determines that the available balance percentage calculated in step 545 is not less than or equal to the current available account balance level percentage in step 550, then the account management module 123 can determine that the purchase has not been completed and, therefore, that the credit limit should not be decreased. Specifically, if the account management module 123 determines that the available balance percentage calculated in step 545 is not less than or equal to the current available account balance level percentage in step 550, then the method 220 branches to step 555 discussed above.

FIG. 6 is a flow chart depicting a method 600 for selecting a credit account, in accordance with certain exemplary embodiments. For example, the method 600 can be used to select a credit account from a pool of credit accounts held by a buyer 105. In certain exemplary embodiments, the method 600 can be used to identify a credit account to use for a purchase of at least one good and/or service from a merchant 110. For example, the credit account identified in the method 600 can be the subject of a temporary credit limit increase, as discussed above, with reference to FIGS. 2-5.

The exemplary method 600 is illustrative and, in alternative embodiments, certain steps can be performed in a different order, in parallel with one another, or omitted entirely, and/or certain additional steps can be performed without departing from the scope and spirit of the invention. The method 600 is described below with reference to FIGS. 1 and 6.

In step 605, the account selection module 121 identifies one or more account selection rules of the buyer 105. For example, the account selection module 121 can receive information regarding the account selection rules directly from the buyer 105 via the interface 124 of the account management system 120. Alternatively, the account selection module 121 can identify information regarding the account selection rules in the database 122.

The account selection rules can include an account balance and an account status of the credit account to be selected. For example, the rules can require the selected credit account to have a $0 balance and to have a closed account status. In certain exemplary embodiments, the account selection module 121 can open a selected credit account having a closed account status. For example, the account selection module 121 can communicate with the account issuer 115 and/or the database 116 of the account issuer 115 to open the credit account.

In step 610, the account selection module 121 identifies one or more credit accounts of the buyer 105. For example, the account selection module 121 can identify the credit accounts in one or more of the databases 122 and 116. In step 615, the account selection module 121 identifies the accounts of the buyer 105 that satisfy the buyer's account selection rules. For example, the account selection module 121 can identify the accounts of the buyer that have the account status and/or account balance specified in the account selection rules.

In step 620, the account selection module 121 determines whether any of the credit accounts identified in step 615 have not been used before. If so, then the method 600 branches to step 625. In step 625, the account selection module 121 selects an account identified in step 615 that has not been used before. Thus, in step 625, the account selection module 121 selects a new credit account for its first use.

If the account selection module 121 determines in step 620 that all of the credit accounts identified in step 615 have been used before, then the method 600 branches to step 630. In step 630, the account selection module 121 selects the account identified in step 615 that has the oldest latest purchase date. In other words, the account selection module 121 selects the account that has been used the least recent. Thus, steps 620-630 ensure that the same card account is not used for successive purchases.

In certain embodiments of the invention, the account management module 123 can transmit an email notification to the merchant 110 with information regarding the selected credit account. For example, the account management module 123 can transmit an email with certain information regarding the buyer 105 and/or the credit account, substantially in accordance with the method 215 of FIG. 4. The email also can include a hyperlink or web site address of a web site at which the merchant 110 can obtain credit account information of the credit account. For example, an authentication procedure can verify the merchant's authority to view the credit account information prior to presenting the information via the web site. By way of example only, the authentication procedure can compare information entered by the merchant 110 at the web site with information received by the buyer 105 in a request to select the credit account and/or information stored in one of the databases 116 and 122.

FIG. 7 is an exemplary interface 700 of an account management system 120, in accordance with certain exemplary embodiments. For example, the interface 700 can be used to submit a request to temporarily increase the credit limit of a credit account to accommodate a purchase. The exemplary interface 700 is illustrative and, in alternative embodiments, certain elements of the interface 700 can be placed in a different position within the interface 700, can be omitted entirely, and/or certain additional elements can be included without departing from the scope and spirit of the invention. The interface 700 is described below with reference to FIGS. 1 and 7.

The interface 700 includes a list 705 of credit accounts of a buyer 105. The list includes an account number, a name, an account status, an email address, a credit limit, a last posted transaction date, and a last posted transaction amount for each credit account identified in the list 705. The list 705 also includes a series of hyperlinks 710 for requesting temporary credit limit increases for the credit accounts. For example, the buyer 105 can request a temporary credit limit increase for the credit account having an account number ending in the digits 4567 by activating the hyperlink 710a associated with the credit account.

In certain exemplary embodiments, activation of the hyperlink 710a can cause a “Request Temporary Credit Limit Increase” frame 715 to be presented. The Request Temporary Credit Limit Increase frame 715 can include one or more data fields 720 for entering information regarding the purchase, including a data field 720d for receiving information regarding the merchant 110, a data field 720c for receiving an invoice number associated with the purchase, and a data field 720e for receiving a description of the purchase and/or other notes related to the purchase. Other of the data fields 720 can receive information specifically related to the temporary credit limit increase. For example, data field 720a can receive a requested increase amount and data field 720b can include a “master accounting code” to be assigned to the temporary credit limit increase. For example, multiple pieces of information regarding the temporary credit limit increase can be associated in the database 122 using the master accounting code.

The Request Temporary Credit Limit Increase frame 715 includes a rule frame 725 with multiple data entry fields 730 for receiving information from the buyer 105 for determining the decrease date of the temporary credit limit increase. Activation of checkbox 730a allows the buyer 105 to establish an expiration date for the temporary credit limit increase. The buyer 105 can activate button 730b to select a specific expiration date. The buyer 105 can enter the expiration date in text field 730c. Alternatively, the buyer can activate button 730d to have the temporary credit limit increase expire after a set number of days. The buyer can enter the number of days in text field 730e.

Activation of checkbox 730f allows the buyer 105 to establish a current available account balance level rule for the temporary credit limit increase. The buyer 105 can activate button 730g to select a current available account balance level dollar amount. The buyer 105 can enter the dollar amount into text field 730h. Alternatively, the buyer can activate button 730i to select a current available account balance level percentage. The buyer 105 can enter the percentage into text field 730j.

The rule frame 725 includes a note 731 specifying that, on the decrease date, the credit limit of the account will be decreased to $0 and the account status will remain at Z9. Thus, the decrease amount for the temporary credit limit increase of FIG. 7 will equal the increase amount. A person of ordinary skill in the art, having the benefit of the present disclosure, will recognize that other suitable decrease amounts exist.

The decrease amount and account status in the note 731 are default values that are not modifiable by the buyer 105. In certain alternative exemplary embodiments, the rule frame 725 can include additional data entry fields for receiving a selected decrease amount and account status from the buyer 105. Similarly, certain other of the data entry fields of the interface 700 can be populated with default data and/or replaced with non-modifiable default data, in certain alternative exemplary embodiments.

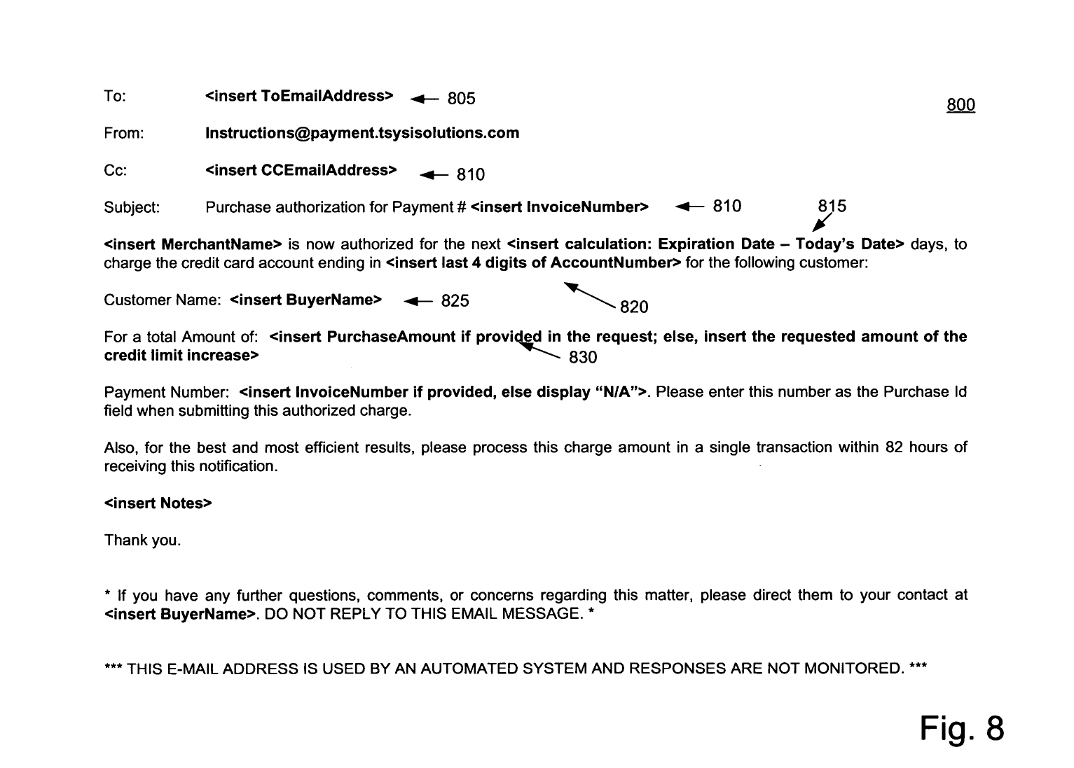

FIG. 8 is an exemplary email notification 800 to a preferred merchant 110 of a buyer 105 of a purchase, in accordance with certain exemplary embodiments. The exemplary email notification 800 is illustrative and, in alternative embodiments, certain elements of the email notification 800 can be placed in a different position within the email notification 800, can be omitted entirely, and/or certain additional elements can be included without departing from the scope and spirit of the invention. The email notification 800 is described below with reference to FIGS. 1 and 8.

The email notification 800 is addressed to an email address 805 of the preferred merchant 110. In certain exemplary embodiments, the email notification 800 also can be addressed to an email address 810 of the buyer 105. For example, a cc: field 810 of the email notification 800 can include the email address 810 of the buyer 105.

The email notification 800 includes information regarding the purchase, such as information identifying the buyer 825, information identifying the purchase, the purchase price 830, and a portion of an account number of the buyer's credit account 820. For example, the information identifying the purchase can include an invoice number 810 associated with the purchase.

The preferred merchant 110 can identify credit account information necessary for processing the purchase with the credit account using the information in the email notification 800. For example, the merchant 110 can match information in the email notification 800 with information already possessed by the merchant 110 to identify the credit account information. By way of example only, the merchant 110 can match the last 4 digits of the credit account 820 presented in the email notification 800 to a list of buyer credit accounts in the merchant's possession.

The email notification 800 also can include information regarding the temporary credit limit increase. For example, the email notification 800 can include information regarding the decrease date, such as information regarding the expiation date 815 of the temporary credit limit increase.

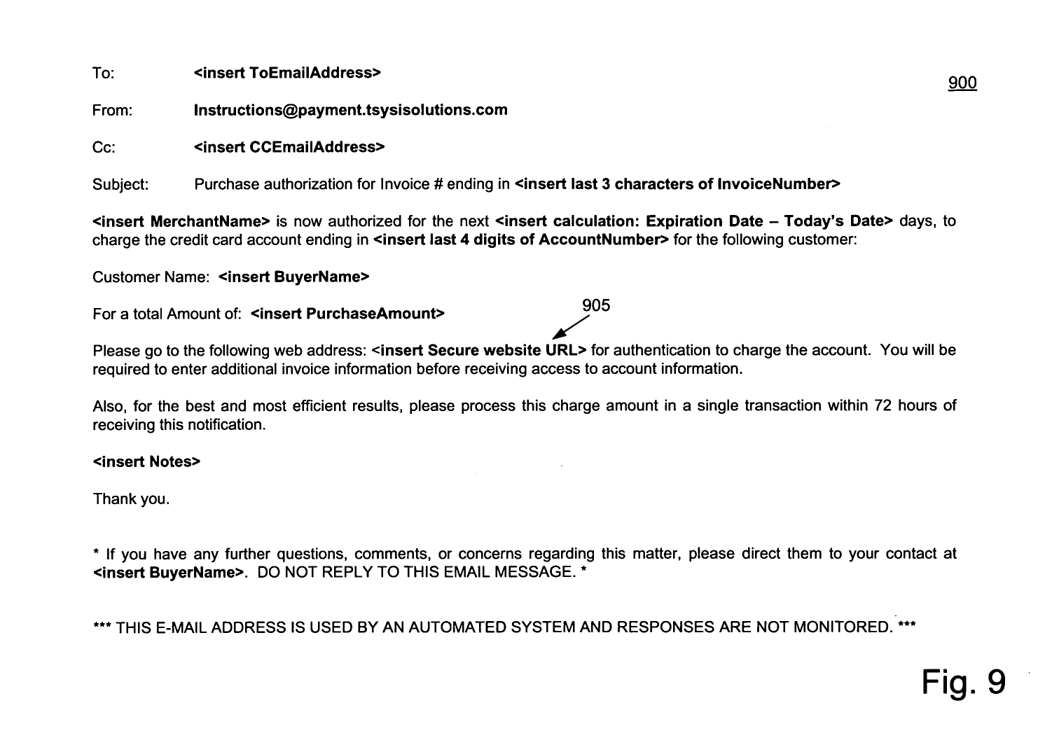

FIG. 9 is an exemplary email notification 900 to a merchant 110 of a purchase, in accordance with certain alternative exemplary embodiments. The exemplary email notification 900 is illustrative and, in alternative embodiments, certain elements of the email notification 900 can be placed in a different position within the email notification 900, can be omitted entirely, and/or certain additional elements can be included without departing from the scope and spirit of the invention. The email notification 900 is described below with reference to FIGS. 1 and 9.

Like the exemplary email notification 800 discussed above with reference to FIG. 8, the email notification 900 of FIG. 9 includes information regarding the purchase and the temporary credit limit increase. The email notification 900 also includes a link and/or a web site address 905 of a secure web site at which the merchant 110 can obtain account information necessary for processing the purchase with the buyer's credit account, as described above with reference to steps 415-435 of FIG. 4.

The invention can be used with computer hardware and software that performs the methods and processing functions described above. As will be appreciated by a person skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments have been described above in detail, the description is merely for purposes of illustration. It should be appreciated, therefore, that many aspects were described above by way of example only and are not intended as required or essential elements unless explicitly stated otherwise. Various modifications of, and equivalent steps corresponding to, the disclosed aspects of the exemplary embodiments, in addition to those described above, can be made by a person skilled in the art without departing from the spirit and scope of the present invention defined in the following claims, the scope of which is to be accorded the broadest interpretation so as to encompass such modifications and equivalent structures.

We claim:

1. A computer-implemented method for managing a credit account, comprising the steps of:
receiving a request to increase a credit limit of a credit account for a purchase by a buyer of at least one good and/or service from a merchant;
increasing a credit limit of the credit account from a first dollar amount to a second dollar amount at a first time, the second dollar amount comprising at least a purchase price of the purchase; and
decreasing the credit limit of the credit account from the second dollar amount to a third dollar amount at a second time, the second time being after the first time.

2. The computer-implemented method of claim 1, wherein the step of decreasing the credit limit of the credit account comprises at least one of updating a credit account record in a computer memory and generating a propagated signal to update a credit account record in a computer memory.

3. The computer-implemented method of claim 1, wherein the step of decreasing the credit limit of the credit account comprises the step of determining to decrease the credit limit of the credit account based on at least one rule associated with the credit account, the at least one rule comprising at least one of an expiration date and a current available account balance level.

4. The computer-implemented method of claim 2, wherein the step of determining to decrease the credit limit of the credit account comprises the step of determining that the second time is on or before the expiration date of the at least one rule.

5. The computer-implemented method of claim 2, wherein the step of determining to decrease the credit limit of the credit account comprises the steps of:
identifying a current available account balance of the credit account; and
determining that the identified available account balance is less than or equal to the current available account balance level of the at least one rule.

6. The computer-implemented method of claim 2, wherein the current available account balance level of the at least one rule comprises one of a percentage and a dollar amount.

7. The computer-implemented method of claim 1, wherein at least one of the at least one rule associated with the credit account is selected by the buyer.

8. The computer-implemented method of claim 1, further comprising the steps of:
determining whether to change a status of the credit account at the second time; and
closing the credit account in response to determining to change the status of the credit account at the second time.

9. The computer-implemented method of claim 8, wherein the step of determining whether to change the status of the credit account at the second time comprises the step of reading at least one rule associated with the credit account, the at least one rule comprising the status to apply to the credit account at the second time.

10. The computer-implemented method of claim 9, wherein the at least one rule associated with the credit account is selected by the buyer.

11. The computer-implemented method of claim 1, wherein the third dollar amount equals the first dollar amount.

12. The computer-implemented method of claim 1, wherein the third dollar amount is $0.

13. The computer-implemented method of claim 1, wherein the step of increasing the credit limit of the credit account comprises the step of transmitting an email to the merchant, notifying the merchant that the purchase can be processed with the credit account.

14. The computer-implemented method of claim 13, wherein the email comprises one of (a) a link to a web site at which the merchant can obtain at least a portion of an account number of the credit account and an expiration date of the credit account upon successful completion of an authentication procedure, and (b) a web address of the web site at which the merchant can obtain the at least the portion of the account number and the expiration date of the credit account upon successful completion of the authentication procedure.

15. A computer-implemented system for managing a credit account, comprising:
an interface comprising at least one field configured to receive information from a buyer planning to complete a purchase of at least one good and/or service from a merchant, the interface configured to generate a request to increase a credit limit of a credit account of the buyer based on information entered by the buyer into the at least one field; and
an account management module configured to:
receive the request to increase the credit limit of the credit account of the buyer from the interface,
increase the credit limit of the credit account from a first dollar amount to a second dollar amount at a first time, the second dollar amount comprising at least a purchase price of the purchase, and
decrease the credit limit of the credit account from the second dollar amount to a third dollar amount at a second time, the second time being after the first time.

16. The computer-implemented system of claim 15, wherein the account management module is configured to communicate with an account issuer of the credit account to increase the credit limit of the credit account and to decrease the credit limit of the credit account.

17. The computer-implemented system of claim 15, wherein the account management module is further configured to determine to decrease the credit limit of the credit account based on at least one rule associated with the credit account, the at least one rule comprising at least one of an expiration date and a current available account balance level.

18. The computer-implemented system of claim 15, further comprising a database storing the at least one rule associated with the credit account.

19. The computer-implemented system of claim 15, wherein the account management module is further configured to:
determine whether to change a status of the credit account at the second time; and
close the credit account in response to determining to change the status of the credit account at the second time.

20. The computer-implemented system of claim 15, wherein the account management module is further configured to determine whether to change the status of the credit account at the second time based on at least one rule associated with the credit account, the at least one rule comprising the status to apply to the credit account at the second time.

21. The computer-implemented system of claim 15, wherein the third dollar amount equals the first dollar amount.

22. The computer-implemented system of claim 15, wherein the third dollar amount is $0.

23. The computer-implemented system of claim 15, wherein the account management module is further configured to transmitting an email to the merchant, notifying the merchant that the purchase can be processed with the credit account.

24. The computer-implemented system of claim 23, wherein the email comprises one of (a) a link to a web site at which the merchant can obtain at least a portion of an account number of the credit account and an expiration date of the credit account upon successful completion of an authentication procedure, and (b) a web address of the web site at which the merchant can obtain the at least the portion of the account number of the credit account and the expiration date of the credit account upon successful completion of the authentication procedure.

25. A computer-implemented method for managing a credit account, comprising the steps of:
receiving information regarding a purchase a buyer plans to complete with a merchant, the information comprising information identifying the buyer, information identifying the merchant, and information identifying the purchase;
generating an email comprising a portion of the received information and including one of a link to a web site and a web address of the web site;
transmitting the email to the merchant;
reading information entered into the web site by the merchant;
determining whether the read information entered into the web site matches at least a portion of the information received in the receiving step but not included in the email transmitted to the merchant; and
providing an account number and expiration date of a credit account of the buyer to the merchant, for use in processing the purchase, in response to determining that the read information entered into the web site matches the portion of the information received in the receiving step but not included in the email transmitted to the merchant.

26. The computer-implemented method of claim 25, wherein the step of providing the account number and expiration date of the credit account comprises the steps of:
generating a signal comprising the account number and expiration date of the credit account; and
transmitting the signal to the merchant via a computer network.

27. The computer-implemented method of claim 25, wherein the email comprises a first portion of an invoice number associated with the purchase, and
wherein the information received in the receiving step but not included in the email transmitted to the merchant comprises a second portion of the invoice number, the second portion of the invoice number being different than the first portion of the invoice number.

28. The computer-implemented method of claim 25, wherein the information received in the receiving step but not included in the email transmitted to the merchant comprises information from an invoice associated with the purchase.
